(19) United States
(12) Patent Application Publication
(10) Pub. No.: US 2026/0176404 A1
(43) Pub. Date: Jun. 25, 2026

(54) POLYURETHANE FOAM WITH ANTIMICROBIAL EFFECT

(71) Applicant: Carl Freudenberg KG, Weinheim (DE)

(72) Inventors: Olivier BEDUE, Weinheim (DE); Karl-Heinz HEFFELS, Pfungstadt (DE)

(21) Appl. No.: 19/124,304

(22) PCT Filed: Oct. 23, 2023
(86) PCT No.: PCT/EP2023/079434

§ 371 Date: Apr. 25, 2025

(30) Foreign Application Priority Data
Oct. 27, 2022 (DE) 10 2022 128 461.1

(51) Int. Cl. C08G 18/08

(52) U.S. Cl. CPC C08G 18/14; C08G 2110/0083

(57) ABSTRACT

A polyurethane foam, including a transition metal oxide. The transition metal oxide is selected from a group consisting of: WO₂, WO₃, MoO₂, MoO₃; and mixtures thereof, hydrates and acids derived from WO₂, WO₃, MoO₂, and/or MoO₃ and mixtures thereof; mixed oxide of general formula MoₓW₁₋ₓM_{y}O_{z}, where M is a cation selected from Na, Cu, Ti, Bi, V, and Zn, where 0≤x≤1, 0≤y≤2, 2≤z≤3, and mixtures thereof; hydrates and acids of general formula MoₓW₁₋ₓM_{y}O_{z}·nH₂O, where M is a cation selected from Na, Cu, Ti, Bi, V, and Zn, where 0≤x≤1, 0≤y≤2, 2≤z≤3, and n describes a number of water molecules, and mixtures thereof; salts of molybdic acid of general formula NₙMoO₄, salts of tungstic acid of general formula NₙWO₄, where N is a cation selected from Na, K, Mg, Ca, Ag, Cu, Bi, V, Ti, Zn, where 1≤n≤2, and mixtures thereof; and mixtures of the transition metal oxides.

### CROSS REFERENCE TO RELATED APPLICATIONS

This application is a U.S. National Phase application under 35 U.S.C. § 371 of International Application No. PCT/EP2023/079434, filed on Oct. 23, 2023 and claims benefit to German Patent Application No. 10 2022 128 461.1, filed on Month Oct. 27, 2022. The International Application was published in German on May 2, 2024 as WO 2024/088941 A1 under PCT Article 21(2).

### FIELD

The invention relates to a polyurethane foam, a method for producing the polyurethane foam, the use thereof, and to a polyurethane foam produced using the method.

### BACKGROUND

Polyurethane foams (PUFs) currently constitute approximately half of all polymer foams produced worldwide and are used for a great number of applications, for example furniture upholstery, carpet underlays, household or industrial sponges, and cosmetic and medicinal purposes, such as absorbent wound dressings.

For some applications, it is expedient for the polyurethane foams to have antimicrobial properties. These antimicrobial properties are generally achieved by admixture or subsequent addition of antimicrobial active substances. As described in EP2720538A1, these antimicrobial active substances are for example based on silver or are antimicrobial powders, such as sodium pyrithione dispersed in plasticizers (U.S. Pat. No. 6,294,589A).

WO2004/007595A1 describes an antimicrobial polyurethane foam, the antimicrobial effect of which is based on silver sodium hydrogen zirconium phosphate. Before the reaction, the antimicrobial active substance is mixed with a polyisocyanate component (i.e., a multifunctional isocyanate) or a polyol component, or both, and is thus incorporated in the polyurethane foam.

U.S. Pat. No. 9,783,676B2 describes an antimicrobial polyurethane foam formed of a multifunctional isocyanate component, an aqueous polyol component which reacts with the multifunctional isocyanate component, an antimicrobial metal compound in the form of silver nanoparticles, and a complexing agent. The complexing agent is used to stabilize the mixture of the antimicrobial metal compound and the polyol component. The antimicrobial metal compound can be a silver, zinc, or copper compound. The antimicrobial metal compound is preferably silver saccharinate.

The use of the known antimicrobial active substances has various disadvantages when they are used for polyurethane foams. For example, silver compounds, which are reduced to metallic silver in the presence of polyurethane precursors, lead to brown or black discoloration of the foam, greatly impairing the appearance of the foam. Water-soluble antimicrobial active substances may be washed away and do not give lasting antimicrobial protection in various applications, for instance household applications. Nanomaterials, in particular silver nanoparticles, also have the disadvantage of falling under the ECHA's Biocidal Products Regulation, and their use requires a specific risk assessment.

Transition metal acids which are based on molybdenum trioxide (MoO₃), such as molybdic acid (H₂MoO₄), also have antimicrobial properties. WO2008/058707A2 describes the use of transition metal oxides which are converted to complex acids in the presence of aqueous media and are used as antimicrobial active substances. The transition metal oxides are especially MoO₃ and WoO₃ and the compounds and derivatives thereof, for example molybdenum suboxides, which act as proton donors following the Bronsted-Lowry definition of acids and bases. Free protons form hydronium ions (H₃O⁺) by addition to water molecules. Depending on the concentration ratio, several water molecules bond to the hydronium ions. In addition to the hydronium ion (H₃O⁺), the Zundel cation (H₅O₂⁺) and the Eigen cation (H₉O₄⁺) are formed. Molybdenum oxide is reacted with water to give molybdic acid (H₂MoO₄), which in turn reacts with H₂O to give H₃O⁺ and MoO₄⁻ or MoO₄²⁻. Tungsten oxide with H₂O forms tungstic acid (H₂WO₄), which in turn reacts with H₂O to give H₃O⁺ and WO₄⁻or WO₄²⁻. The reaction of the metal oxides with water to give metal acids causes the pH at the surface of an object to be lowered, thereby achieving an antimicrobial effect.

This technology, the associated method, and the applications in the production of objects and coatings having an antimicrobial effect, in particular for applications in the fields of medical technology, healthcare facilities, and household appliances, are also described in US20160106108A1 and US20190029259A1. However, if the objects are in the form of tightly packed solid bodies, only the surface has an effective antimicrobial effect. Thus, a large proportion of the active substance in the solid body remains unutilized. Alternatively, the antimicrobial active substance can be applied to the solid body as part of a coating. However, this requires an additional process step. Furthermore, the antimicrobial effect is lost if the coating is damaged or worn away.

EP3643177A1 describes the use of a triclinic form of zinc molybdate (ZnMoO₄) particles having a mean particle size of between 0.25 μm and 5.0 μm as an antimicrobial active substance. In this case, the antimicrobial effect can be achieved by triclinic zinc molybdate alone or in combination with further active substances having different crystal structures, but preferably with molybdenum trioxide MoO₃ having an orthorhombic crystal structure. Triclinic zinc molybdate alone or in combination with further active substances can be incorporated in a material which is intended to have antimicrobial properties, or applied to the surface thereof. This gives an antimicrobially effective composite material which greatly hinders colonization by pathogenic microorganisms and for which the antimicrobial effect is maintained over the entire service life of the composite material because the insolubility of triclinic zinc molybdate in water means it is not washed away. In principle, the composite material can be chosen from any desired class of materials.

### SUMMARY

In an embodiment, the present disclosure provides a polyurethane foam, comprising at least one transition metal oxide as an antimicrobial active substance. The transition metal oxide is selected from a group consisting of: WO2, WO3, MoO2, MoO3; and mixtures thereof, hydrates and acids derived from WO2, WO3, MoO2, and/or MoO3 and mixtures thereof, mixed oxide of general formula MoxW1-xMyOz, where M is a cation selected from Na, Cu, Ti, Bi, V, and Zn, wherein 0≤x≤1, 0≤y≤2, 2≤z≤3, and mixtures thereof, hydrates and acids of general formula MoxW1-xMyOz·nH2O, where M is a cation selected from Na, Cu, Ti, Bi, V, and Zn, wherein 0≤x≤1, 0≤y≤2, 2≤z≤3, and n describes the number of water molecules, and mixtures thereof; molybdate, in particular salts of molybdic acid of general formula NnMoO4, tungstate, in particular salts of tungstic acid of general formula NnWO4, where N is a cation selected from Na, K, Mg, Ca, Ag, Cu, Bi, V, Ti, Zn, wherein 1≤n≤2, and mixtures thereof, and mixtures of the transition metal oxides of the foregoing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 depicts a distribution of the measured regions and ascertained differences in concentration for a foam slabstock associated with exemplary embodiment 2, in accordance with embodiments of the present disclosure.

### DETAILED DESCRIPTION

In an embodiment, the present disclosure provides a polyurethane foam which has an antimicrobial effect, by means of which it is possible to overcome the above-mentioned disadvantages, at least in part. In particular, a durable antimicrobial effect can be achieved which is not impaired by washing operations. Furthermore, in spite of the antimicrobial active substance, the polyurethane foam can be produced without, or with only slight, discoloration, and the polyurethane foam should preferably be able to satisfy regulatory requirements under the Biocidal Products Regulation (BPR, Regulation (EU) 528/2012). Furthermore, the antimicrobial active substance can be distributed within the product so as to maintain an antimicrobial effect even if the surface of the product is damaged.

The foregoing is achieved by a polyurethane foam containing at least one transition metal oxide as an antimicrobial active substance, wherein the transition metal oxide is selected from the group consisting of
I. WO₂, WO₃, MoO₂, MoO₃, and mixtures thereof,
II. hydrates and acids derived from WO₂, WO₃, MoO₂, and/or MoO₃, preferably WO₃·H₂O, WO₃·2H₂O, MoO₂·H₂O, MoO₂·2H₂O, MoO₂·3H₂O, and mixtures thereof,
III. mixed oxide of general formula MoₓW₁₋ₓM_{y}O_{z}, where M is a cation selected from Na, Cu, Ti, Bi, V, and Zn, wherein 0<x<1, 0≤y≤2, 2≤z≤3, and mixtures thereof,
IV. hydrates and acids of general formula MoₓW₁₋ₓM_{y}O_{z} nH₂O, where M is a cation selected from Na, Cu, Ti, Bi, V, and Zn, wherein 0<x<1, 0≤y≤2, 2≤z≤3, and n describes the number of water molecules, and mixtures thereof,
V. molybdate, in particular salts of molybdic acid of general formula NₙMoO₄, tungstate, in particular salts of tungstic acid of general formula NₙWO₄, where N is a cation selected from Na, K, Mg, Ca, Ag, Cu, Bi, V, Ti, Zn, wherein 1≤n≤2, and mixtures thereof,
VI. mixtures of the transition metal oxides of groups I to V.

The transition metal oxides of groups I to V can optionally be present in a mixture with other transition metal oxides of the same or different groups.

Surprisingly, it was found that a high antimicrobial effect can be achieved with the polyurethane foam according to the present disclosure, with this antimicrobial effect also being able to withstand washing operations. Furthermore, practical experiments showed that the antimicrobial effect is even strengthened by washing operations. This was particularly surprising since the effect of conventional antimicrobial active substances is reduced by washing operations. Furthermore, in spite of the antimicrobial active substance, the polyurethane foam can be produced without, or with only slight, discoloration, and the polyurethane foam is also able to satisfy regulatory requirements under the Biocidal Products Regulation (BPR, Regulation (EU) 528/2012). Zinc molybdate has already been reported to be a successful biocidal active substance. A further advantage of the transition metal oxides used as an antimicrobial active substance is that they are water-insoluble and virtually non-toxic.

An antimicrobial active substance is understood to be a chemical substance which is able to kill microorganisms or at least inhibit their growth. The transition metal oxides according to the present disclosure are particularly suitable for this because, due to the reaction of the metal oxides with water to give metal acids, they lower the pH at the surface of an object to 4 to 5 and can thereby achieve an antimicrobial effect. Aside from their acidic properties, these transition metal oxides are also semiconductors with a specific bandgap. Energy in the form of light can transfer electrons from the valence band to the conduction band. Both the electrons in the conduction band and the electron holes in the valence band can react with water or oxygen and form oxide radicals, which are also very effective in oxidizing organic materials and killing microbes.

In an embodiment of the present disclosure, the transition metal oxide is distributed, preferably homogeneously, within the polyurethane foam. In contrast to products that contain the transition metal oxide merely as a coating, this makes it possible to maintain an antimicrobial effect even if the surface of the product is damaged.

In an embodiment of the present disclosure, the transition metal oxide is a transition metal oxide of group I, optionally mixed with transition metal oxides of groups II to V.

In an embodiment of group I, the transition metal oxide is selected from the group consisting of MoO₂, MoO₃, and mixtures thereof. In an embodiment, the transition metal oxide is MoO₂. MoO₂ can be readily obtained from MoO₃ by reduction and is advantageous because it is non-toxic and water-insoluble. MoO₃ has the advantage of having low water solubility, of 1 g/l, and low toxicity.

In an embodiment of the present disclosure, the transition metal oxide is a transition metal oxide of group II, optionally mixed with transition metal oxides of groups I or III to V.

In an embodiment of group II, the transition metal oxide is selected from the group consisting of hydrates and acids derived from MoO₂ and/or MoO₃, preferably MoO₂·H₂O, MoO₂·2H₂O, MoO₂·3H₂O, and mixtures thereof.

In an embodiment of the present disclosure, the transition metal oxide is a transition metal oxide of group III, optionally mixed with transition metal oxides of groups I to II or IV to V.

In an embodiment of group III, the transition metal oxide is selected from the group consisting of mixed oxides of general formula MoₓW₁₋ₓM_{y}O_{z}, where M is Zn and wherein 0<x<1, 0≤y≤2, 2≤z≤3, and mixtures thereof.

In an embodiment of the present disclosure, the transition metal oxide is a transition metal oxide of group IV, optionally mixed with transition metal oxides of groups I to III or V.

In an embodiment of group IV, the transition metal oxide is selected from the group consisting of hydrates and acids of general formula MoₓW₁₋ₓM_{y}O_{z} nH₂O, where M is Zn and wherein 0<x<1, 0≤y≤2, 2≤z≤3, and n describes the number of water molecules, and mixtures thereof.

In an embodiment of the present disclosure, the transition metal oxide is a transition metal oxide of group V, optionally mixed with transition metal oxides of groups I to IV.

In an embodiment of group V, the transition metal oxide is selected from molybdate, in particular salts of molybdic acid of general formula NₙMoO₄, tungstate, in particular salts of tungstic acid of general formula NₙWO₄, where N is a cation selected from Na, K, Mg, Ca, Ag, Cu, Bi, V, Ti, Zn, wherein 1≤n≤2, and mixtures thereof, optionally mixed with transition metal oxides of groups I to IV.

In an embodiment of group V, the transition metal oxide is molybdate, in particular a salt of molybdic acid of general formula NₙMoO₄, where N is a cation selected from Na, K, Mg, Ca, Ag, Cu, Bi, V, Ti, Zn, wherein 1≤n≤2, and mixtures thereof.

In an embodiment of group V, N is a cation selected from Na, K, Zn, Ag, and Cu. The advantage of Ag and Cu is that these cations themselves have antibacterial properties. Thus, silver molybdate (Ag₂MoO₄), copper molybdate (CuMoO₄), and mixtures thereof are preferred. In an embodiment of group V, the transition metal oxide is zinc molybdate (ZnMoO₄), sodium molybdate (Na₂MoO₄), potassium molybdate (K₂MoO₄), and/or mixtures thereof, in particular zinc molybdate. The advantage of zinc molybdate (ZnMoO₄) is that it has only low solubility in water and therefore cannot be washed away from the polyurethane foam.

In an embodiment, the transition metal oxide is zinc molybdate (ZnMoO₄). As explained above, the zinc molybdate (ZnMoO₄) can optionally be present with other transition metal oxides of groups I to V. As set out above, the advantage of ZnMoO₄ is firstly its insolubility in water and secondly its colorlessness, which leads to no, or only slight, discoloration in the polymer foam.

In an embodiment, the ZnMoO₄ has the tetragonal crystal structure. More preferably, the ZnMoO₄ has the triclinic crystal structure. The advantage of this is that ZnMoO₄ having this crystal structure is a chemical produced in large quantities and is therefore readily available.

In an embodiment, the proportion of the transition metal oxide is 0.05 wt % to 5 wt %, more preferably 0.1 wt % to 3 wt %, in particular 0.15 wt % to 1 wt %, in each case relative to the total weight of the polyurethane foam. These concentration ranges have proven advantageous since they give very good antimicrobial efficacy which is still present after several washing cycles. Furthermore, at these quantities, the properties of the polyurethane foam, for example the feel, porosity, and color, are not influenced or are only influenced to a very limited extent.

Preferably, the transition metal oxide is in particulate form, in particular having a mean diameter of 0.1 μm to 500 μm, more preferably 0.2 μm to 300 μm, more preferably 0.3 μm to 250 μm, more preferably 0.5 μm to 50 μm, more preferably 1 μm to 20 μm, in each case measured according to ISO 13320:2009.

The above-mentioned particle sizes are advantageous because they enable very homogeneous distribution of the antibacterial active substance in the polyurethane foam and a good antibacterial effect on contact with water.

In an embodiment, the polyurethane foam has a density of 10 to 100 kg/m³, preferably 15 to 50 kg/m³, more preferably 15 to 30 kg/m³, in each case measured according to DIN 53420:1978. These densities have been found to give good water absorbability, and water can be easily released when the polyurethane foam is wrung out.

The mean pore size of the polyurethane foam is preferably 0.01 to 10 mm, preferably 0.01 to 5 mm, and more preferably 0.1 to 1 mm, in each case measured according to ASTM E 1294:1994. The advantage of this pore size is that it makes it possible to obtain a homogeneous surface that can be readily modified further, for example printed on.

Furthermore, the polyurethane foam preferably has a compressive strength, according to ISO 3386-1:1998, at 40% deformation of 1 to 10 kPa, preferably 2 to 7 kPa, more preferably 3 to 5 kPa. The advantage of these compressive strengths is that the polyurethane foam can readily return to its initial form after being wrung out.

The tensile strength of the polyurethane foam is preferably 30 to 300 kPa, preferably 50 to 250 kPa, and more preferably 100 to 200 kPa, in each case measured according to DIN ISO 1798:2008. The advantage of these mechanical strengths is that the polyurethane foam has good tearing strength and thus can be used for a long period of time.

Preferably, the polyurethane foam is produced by reacting diisocyanates, preferably diphenylmethane-2,2′-diisocyanate (MDI) and/or toluene-2,4-diisocyanate (TDI) with polyols, preferably polyester polyols and/or polyether polyols.

Examples of polyether polyols include adducts of polyhydric alcohols, preferably ethylene glycol, propylene glycol, glycerol, trimethylolpropane, pentaerythritol and/or sucrose with alkylene oxide, preferably ethylene oxide, propylene oxide and/or butylene oxide; adducts of amines, preferably diethanolamine, triethanolamine and/or ethylenediamine, with alkylene oxide, preferably ethylene oxide, propylene oxide and/or butylene oxide; and graft-type polymer polyol, derived from styrene or acrylonitrile.

Examples of polyester polyols include polyester polyol with terminal hydroxyl, and polycaprolactone. The former can be obtained by polymerization of an aliphatic carboxylic acid, preferably malonic acid, succinic acid and adipic acid, or an aromatic carboxylic acid, preferably phthalic acid and terephthalic acid or a mixture thereof, with an aliphatic glycol, such as ethylene glycol, propylene glycol or diethylene glycol or a triol; preferably trimethylolpropane and glycerol. Polycaprolactone is preferably produced by ring-opening polymerization of ε-caprolactone.

The polyol preferably has a number-average molecular weight of 600 g/mol to 6000 g/mol, more preferably 1000 g/mol to 5000 g/mol, measured according to DIN 55672-1:2016-03.

The diisocyanate that can be used in the present disclosure is preferably an organic compound that contains two isocyanate groups in one molecule. It includes aliphatic isocyanates, aromatic isocyanates, mixtures thereof, and derivatives thereof. Examples of aliphatic isocyanates include hexamethylene diisocyanate, isophorone diisocyanate, and methylcyclohexane diisocyanate. Examples of aromatic isocyanates include toluene diisocyanate (2,4- and/or 2,6-isomers), diphenylmethane diisocyanate, and bitoluene diisocyanate. In an embodiment, diphenylmethane-2,2′-diisocyanate (MDI) and/or toluene-2,4-diisocyanate (TDI) are particularly preferred. According to the present disclosure, the isocyanate index for producing the polyurethane foam is preferably in a range from 0.5 to 5. The isocyanate index is the excess of isocyanate relative to the theoretical quantity for (1:1) reaction with all the active OH groups of the polyol, expressed as a percentage. In other words, isocyanate index=100×(quantity of NCO actually used)/(quantity of NCO theoretically required).

The polyurethane foam is preferably produced from a formulation containing a blowing agent. The blowing agent is preferably water, which can react with diisocyanate to give carbamic acid, which decomposes to give amine and CO₂.

In an embodiment, the water is used in combination with a low-boiling organic compound, preferably a halogenated hydrocarbon, optionally including trichlorofluoromethane and methylene chloride, or with a gas, preferably air and carbon dioxide.

Further preferably, the formulation contains additives, for example pigments, surfactants, antioxidants, plasticizers, fillers, and/or dyes. The proportion of the additives, if present, is preferably 0.0005 wt % to 5 wt %, more preferably 0.005 wt % to 2.5 wt %, in particular 0.01 wt % to 1.5 wt %, relative to the total weight of the polyurethane foam. In a further embodiment, the formulation contains an organic amine or tin catalyst.

According to the present disclosure, one or more further antimicrobial active substances can be used in addition to the transition metal oxide. However, this was found in practical experiments not to be necessary. Thus, in an embodiment, the polyurethane foam does not comprise any further antimicrobial active substances or only comprises further antimicrobial active substances in a proportion of less than 5 wt %, more preferably less than 3 wt %, more preferably less than 2 wt %, more preferably less than 1 wt %, in each case relative to the total weight of the polyurethane foam. According to the present disclosure, further antimicrobial active substances are understood to be antimicrobial active substances which are not transition metal oxides selected from groups I to VI.

In an embodiment, the polyurethane foam is in the form of an antimicrobially effective sponge and/or sponge cloth. The sponge preferably has a thickness of 1.5 cm to 6 cm, preferably 2 cm to 5 cm, and/or the sponge cloth has a thickness of between 0.5 cm and 1 cm. The thickness of sponge and/or sponge cloth is measured according to ASTM D3574-03:2003. An electronic measuring device having a plate of at least 650 mm² and a pressure of 170 Pa is used.

The present disclosure also relates to a sponge and/or sponge cloth containing the polyurethane foam according to the present disclosure. In an embodiment, a sponge is particularly preferred, since this can be more easily obtained in the process.

In an embodiment, the sponge and/or the sponge cloth has an at least two-part construction, a first part having the polyurethane foam and a second part being a rough, abrasive-like component.

The polyurethane foam according to the present disclosure preferably has antimicrobial properties, measured according to JIS L 1902:2015, against Staphylococcus aureus (Gram+) and/or Klebsiella pneumoniae (Gram−) with an incubation time of 18 hours, having a total antibacterial activity=log [CFU]_{IGC 18h}−log [CFU]_{sample 18h}, CFU standing for colony forming units and IGC for internal growth control, of at least 0.5, for example 0.5 to 8, or 0.5 to 7, or 0.5 to 6, or 0.5 to 5, or 0.5 to 4.5, preferably of at least 1, for example 1 to 8, or 1 to 7, or 1 to 6, or 1 to 5, or 1 to 4.5, more preferably of at least 1.5, for example 1.5 to 8, or 1.5 to 7, or 1.5 to 6, or 1.5 to 5, or 1.5 to 4.5, or of at least 2, for example 2 to 8, or 2 to 7, or 2 to 6, or 2 to 5, or 2 to 4.5.

The polyurethane foam according to the present disclosure preferably has antimicrobial properties, measured according to JIS L 1902:2015, against Staphylococcus aureus (Gram+) and/or Klebsiella pneumoniae (Gram−) with an incubation time of 18 hours, having a total antibacterial activity=log [CFU]_{IGC 18h}−log [CFU]_{sample 18h}, CFU standing for colony forming units and IGC for internal growth control, after a washing cycle at 60° for one hour using detergent in the cotton washing program with spinning at 1400 rpm, of at least 0.5, for example 0.5 to 8, or 0.5 to 7, or 0.5 to 6, or 0.5 to 5, or 0.5 to 4.5, preferably of at least 1, for example 1 to 8, or 1 to 7, or 1 to 6, or 1 to 5, or 1 to 4.5, more preferably of at least 1.5, for example 1.5 to 8, or 1.5 to 7, or 1.5 to 6, or 1.5 to 5, or 1.5 to 4.5, or of at least 2, for example 2 to 8, or 2 to 7, or 2 to 6, or 2 to 5, or 2 to 4.5.

It is assumed that the increase in antimicrobial effect after the polyurethane foam is washed can be attributed to activation of the surface. In turn, this activation is assumed to be due to better accessibility of the transition metal oxide particles because of the friction caused by the washing operation. Furthermore, washing appears to lead to a partial reduction of the oxidation state of the transition metal oxides, such that they are present as a mixture of different oxidation states, causing further improved antimicrobial efficacy.

In an embodiment, during the production of the polyurethane foam, the antimicrobial active substance is used in the form of particles having a mean diameter of 0.1 μm to 500 μm, more preferably 0.2 μm to 300 μm, more preferably 0.3 μm to 250 μm, more preferably 0.5 μm to 50 μm, in particular 1 μm to 20 μm, in each case measured according to ISO 13320:2009. These particle sizes have proven particularly suitable for achieving effective and homogeneous distribution of the antibacterial active substance in the polyurethane foam; at the same time, they enable a good antibacterial effect on contact with water.

In an embodiment of the present disclosure, the antimicrobial active substance is added to the starting materials used in the production of the polyurethane foam. The active substance is preferably added to the polyol.

The present disclosure also relates to a method for producing a polyurethane foam containing at least one transition metal oxide as an antimicrobial active substance, the method comprising the following steps:
a) providing a transition metal oxide selected from the group consisting of:
   I. WO₂, WO₃, MoO₂, MoO₃, and mixtures thereof,
   II. hydrates and acids derived from WO₂, WO₃, MoO₂, and MoO₃, preferably WO₃·H₂O, WO₃·2H₂O, MoO₂·H₂O, MoO₂·2H₂O, MoO₂·3H₂O, and mixtures thereof,
   III. mixed oxide of general formula MoₓWi₁₋ₓM_{y}O_{z}, where M is a cation selected from Na, Cu, Ti, Bi, V, and Zn, wherein 0≤x≤1, 0≤y≤2, 2≤z≤3, and mixtures thereof,
   IV. hydrates and acids of general formula MoₓW₁₋ₓM_{y}O_{z} nH₂O, where M is a cation selected from Na, Cu, Ti, Bi, V, and Zn, wherein 0≤x≤1, 0≤y≤2, 2≤z≤3, and n describes the number of water molecules, and mixtures thereof;
   V. molybdate, in particular salts of molybdic acid of general formula NₙMoO₄, tungstate, in particular salts of tungstic acid of general formula NₙWO₄, where N is a cation selected from Na, K, Mg, Ca, Ag, Cu, Bi, V, Ti, Zn, wherein 1≤n≤2, and mixtures thereof,
   VI. mixtures of the transition metal oxides of groups I to V;
b1) producing a pre-dispersion, comprising dispersing at least one transition metal oxide selected from groups I to VI as an antimicrobial active substance in water, and mixing the pre-dispersion with polyol to form a polyol dispersion; or
b2) producing a polyol dispersion, comprising dispersing at least one transition metal oxide selected from groups I to VI as an antimicrobial active substance in polyol and water;
c) reacting the polyol dispersion from step b1) or b2) with diisocyanate to form the polyurethane foam.

Embodiments of the method according to the present disclosure comprise embodiments described in relation to the polyurethane foam according to the present disclosure, mutatis mutandis.

In step b1), a pre-dispersion is produced, comprising dispersing at least one transition metal oxide as an antimicrobial active substance in water, the transition metal oxide being selected from groups I to VI, and mixing the pre-dispersion with polyol to form a polyol dispersion. Preferably, in step b1), the transition metal oxide is dispersed in a quantity of water such that the pre-dispersion comprises a proportion of transition metal oxide in the range from 1 wt % to 50 wt %, relative to the total weight of the pre-dispersion. Customary auxiliaries such as pigments and additives can also be added to the pre-dispersion. It is advantageous here that homogeneous distribution of the transition metal oxide in the polyurethane foam can be obtained.

Step b2) comprises an alternative production of a polyol dispersion, comprising dispersing at least one transition metal oxide as an antimicrobial active substance in polyol and water, the transition metal oxide being selected from groups I to VI.

In both step b1) and step b2), a concentration of 0.001 wt % to 10 wt %, preferably 0.005 wt % to 5 wt %, particularly preferably 0.01 wt % to 3 wt %, of the transition metal oxide relative to the total weight of the polyol dispersion is preferably set. The transition metal is preferably homogeneously mixed with the polyol and water. In an embodiment, additives, for example pigments, surfactants, antioxidants, plasticizers, fillers, and/or dyes, are added to the polyol dispersion. The additives are preferably added to the polyol dispersion in a quantity such that the proportion thereof is 0.0005 wt % to 5 wt %, preferably 0.005 wt % to 2.5 wt %, particularly preferably 0.01 wt % to 1.5 wt % relative to the total weight of the resulting polyurethane foam.

In step c), the polyol dispersion is reacted with diisocyanate to form the polyurethane foam. Because of the water contained in the pre-dispersion (step b1), which can react with diisocyanate to give carbamic acid, the carbamic acid decomposes to give amine and CO₂, enabling the polyurethane foam to be formed.

In an embodiment, the method according to the present disclosure is carried out continuously. The resulting continuous polyurethane foam strand can be cut into slabs of the desired dimensions.

Preferably, a polyurethane foam according to the present disclosure, in accordance with one of the embodiments described herein, is produced using the method according to the present disclosure.

The present disclosure also relates to a polyurethane foam produced using the method according to the present disclosure.

The polyurethane foam, sponge, and/or sponge cloth according to the present disclosure are exceptionally well-suited to cleaning a wide variety of surfaces. Because of the high antimicrobial properties, the products have a long shelf life and remain odor-neutral for a long time. Surprisingly, it was also found that a particularly homogeneous distribution of the antimicrobial active substance in the polyurethane foam can be obtained.

The present disclosure is described in more detail below by means of non-limiting exemplary embodiments.

### Exemplary Embodiment 1: Laboratory-Scale Production of a Polyurethane Foam According to the Present Disclosure

A polyurethane foam according to the present disclosure was produced on a laboratory scale. The components used for the production were as follows:
Component A (polyether polyol): EP 4417=100 g
Component B (isocyanate/TDI): puronate® 946 from Rühl Puromer GmbH=56 g
ZnMoO₄: 0.3 g (resulting in 0.2% in the end product, AB400454, from ABCR GmbH, 99% purity).

The characteristic data of the components used were as shown in Table 1, below:

TABLE 1

| | Density (20° C.) | Viscosity (25° C.) |
|---|---|---|
| EP 4417 | 1.03 g/cm³ | 1500 mPas |
| puronate ® 946 | 1.19 g/cm³ | 70 mPas |

A pre-dispersion of water and ZnMoO₄ was produced and mixed with the polyol. The isocyanate was then added to the resulting polyol dispersion, with stirring. A very homogeneous distribution of the ZnMoO₄ was achieved in the product.

### Exemplary Embodiment 2: Production of a Polyurethane Foam According to the Present Disclosure as Foam Slabstock

Granular zinc molybdate (AB400454, from ABCR GmbH, 99% purity) having particle sizes of less than 65 m was mixed with aliphatic polyether polyol (EP 4417), pigments, additives, and water, giving a polyol dispersion. Zinc molybdate was weighed in such that a concentration of 0.3 wt % of the antimicrobial active substance was obtained in the end product, the polyurethane foam. Toluene-2,4-diisocyanate (TDI, puronate® 946) was used as diisocyanate. The TDI was homogeneously mixed with the polyol dispersion in a mixing head and laid down continuously on a conveyor belt. Because of the water contained in the pre-dispersion, which can react with diisocyanate to give carbamic acid, the carbamic acid decomposed to give amine and CO₂, as a result of which the polyurethane foam was formed. This gave a polyurethane foam slabstock having a length of 120 m and a density of 20 kg/m³. A sponge was cut out of the polyurethane foam slabstock.

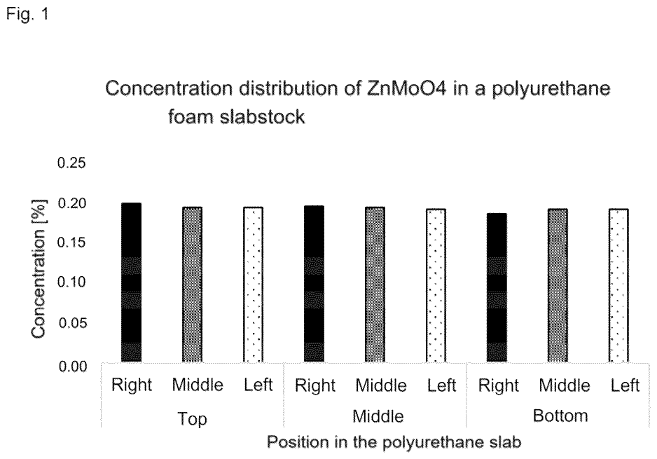

The distribution of the zinc molybdate over the cross section of the foam slabstock was determined using atomic emission spectroscopy (ICP-OES) elemental analysis following acidic microwave digestion of samples incinerated in a platinum crucible. It is clear that the zinc molybdate is surprisingly very homogeneously distributed, with a mean of 0.194%±0.004%. This value was ascertained over nine different, equally-sized regions of the foam slabstock. The distribution of the measured regions and the ascertained differences in concentration are shown in FIG. 1.

The polyurethane foam obtained was tested for its antimicrobial efficacy according to JIS L 1902:2015. A polyurethane foam of the same type but containing no antimicrobial active substance was used as a reference.

It was apparent that there was high antimicrobial efficacy against Staphylococcus aureus and Klebsiella pneumoniae. Surprisingly, the antimicrobial efficacy increased again with a washing cycle at 60° for one hour using detergent in the cotton washing program with spinning at 1400 rpm. It is assumed that this unexpected increase in efficacy is caused by activation of the surface. Furthermore, washing appears to lead to a partial reduction of the oxidation state of the transition metal oxides, such that they are present as mixtures of different oxidation states, having further improved antimicrobial efficacy. Furthermore, the transition metal oxides according to the present disclosure have very good adhesion to the polyurethane foam, and so they are not washed away or are only washed away to a limited extent.

The results are given in Table 2, below:

TABLE 2

| Log. reduction of strains / log | S. | K. |
|---|---|---|
| [CFU]_{IGC 18 h} - log [CFU]_{sample 18 h} | aureus | pneumoniae |
| Unwashed control | 0 | 0.01 |
| Unwashed 0.3% zinc molybdate / top right | 2.5 | 1.7 |
| Unwashed 0.3% zinc molybdate / middle middle | 3.1 | 3 |
| Unwashed 0.3% zinc molybdate / bottom left | 2.8 | 1.9 |
| Washed control | 0.3 | 0 |
| Washed 0.3% zinc molybdate / top right | 3.9 | 4 |
| Washed 0.3% zinc molybdate / middle middle | 3.2 | 3.8 |
| Washed 0.3% zinc molybdate / bottom left | 3.7 | 3.6 |

### Exemplary Embodiment 3: Testing the Antimicrobial Effect of Two Polyurethane Foams not According to the Present Disclosure

The antimicrobial effect of two polyurethane foams not according to the present disclosure was tested before and after washing. The antimicrobial effect was tested analogously to exemplary embodiment 2. Comparative foam 1 contained 5 wt %, relative to the total weight of the foam, of homogeneously distributed butyl benzisothiazolinone as the antimicrobial active substance. Comparative foam 2 contained 0.3 wt %, relative to the total weight of the foam, of homogeneously distributed zinc pyrithione and thiabendazole as the antimicrobial active substance. Both foams were washed with a washing cycle at 60° C. for 1.5 hours using detergent in the cotton washing program with spinning at 1400 rpm. A significant reduction in the antimicrobial effect by a factor of 10 to 100 due to the washing was observed for both foams. The reduction in the antimicrobial effect is assumed to be due to the antimicrobial active substance being washed away by the washing operation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A polyurethane foam, comprising:
at least one transition metal oxide as an antimicrobial active substance, wherein the transition metal oxide is selected from a group consisting of;
I. WO₂, WO₃, MoO₂, MoO₃, and mixtures thereof,
II. hydrates and acids derived from WO₂, WO₃, MoO₂, and/or MoO₃ and mixtures thereof,
III. mixed oxide of general formula MoₓW₁₋ₓM_{y}O_{z}, where M is a cation selected from Na, Cu, Ti, Bi, V, and Zn, wherein 0≤x≤1, 0≤y≤2, 2≤z≤3, and mixtures thereof,
IV. hydrates and acids of general formula MoₓW₁₋ₓM_{y}O_{z}·nH₂O, where M is a cation selected from Na, Cu, Ti, Bi, V, and Zn, wherein 0≤x≤1, 0≤y≤2, 2≤z≤3, and n describes a number of water molecules, and mixtures thereof,
V. molybdate, in particular salts of molybdic acid of general formula NₙMoO₄, tungstate, in particular salts of tungstic acid of general formula NₙWO₄, where N is a cation selected from Na, K, Mg, Ca, Ag, Cu, Bi, V, Ti, Zn, wherein 1≤n≤2, and mixtures thereof, and
VI. mixtures of the transition metal oxides of groups I to V.

2. The polyurethane foam according to claim 1, wherein the transition metal oxide is selected from the salts of molybdic acid of general formula NₙMoO₄, the salts of tungstic acid of general formula NₙWO₄, where N is a cation selected from Na, K, Mg, Ca, Ag, Cu, Bi, V, Ti, Zn, wherein 1≤n≤2, and mixtures thereof.

3. The polyurethane foam according to claim 1, wherein the transition metal oxide is ZnMoO₄, Na₂MoO₄, K₂MoO₄, and/or mixtures thereof, is ZnMoO₄.

4. The polyurethane foam according to claim 1, wherein a proportion of the transition metal oxide is 0.05 wt % to 5 wt % relative to a total weight of the polyurethane foam.

5. The polyurethane foam according to claim 1, wherein the transition metal oxide is in particulate form having a mean diameter of 0.1 μm to 500 μm measured according to ISO 13320:2009.

6. The polyurethane foam according to claim 1, wherein the transition metal oxide is distributed homogeneously; within the polyurethane foam.

7. The polyurethane foam according to claim 1, wherein the polyurethane foam has a mean pore size of 0.01 to 10 mm measured according to ASTM E 1294:1994.

8. The polyurethane foam according to claim 1, wherein the polyurethane foam does not comprise any further antimicrobial active substances relative to a total weight of the polyurethane foam.

9. The polyurethane foam according to claim 1, wherein the polyurethane foam is in a form of sponge and/or sponge cloth.

10. The polyurethane foam according to claim 1, wherein the polyurethane foam is in a form of foam slabstock.

11. A method for cleaning a surface, comprising:
providing the polyurethane foam according to claim 1; and
cleaning the surface with the polyurethane foam.

12. A method for producing a polyurethane foam, comprising at least one transition metal oxide as an antimicrobial active substance, wherein the method comprises the following steps:
a) providing the transition metal oxide selected from a group consisting of:
I. WO₂, WO₃, MoO₂, MoO₃, and mixtures thereof,
II. hydrates and acids derived from WO₂, WO₃, MoO₂, and MoO₃, and mixtures thereof,
III. mixed oxide of general formula MoₓW₁₋ₓM_{y}O_{z}, where M is a cation selected from Na, Cu, Ti, Bi, V, and Zn, wherein 0≤x≤1, 0≤y≤2, 2≤z≤3, and mixtures thereof,
IV. hydrates and acids of general formula MoₓW₁₋ₓM_{y}O_{z}·nH₂O, where M is a cation selected from Na, Cu, Ti, Bi, V, and Zn, wherein 0≤x≤1, 0≤y≤2, 2≤z≤3, and n describes a number of water molecules, and mixtures thereof,
V. molybdate, in particular salts of molybdic acid of general formula NₙMOO₄, tungstate, in particular salts of tungstic acid of general formula NₙWO₄, where N is a cation selected from Na, K, Mg, Ca, Ag, Cu, Bi, V, Ti, Zn, wherein 1≤n≤2, and mixtures thereof, and
VI. mixtures of the transition metal oxides of groups I to V;
b1) producing a pre-dispersion, comprising dispersing the at least one transition metal oxide selected from groups I to VI as the antimicrobial active substance in water, and mixing the pre-dispersion with polyol to form a polyol dispersion; or
b2) producing a polyol dispersion, comprising dispersing the at least one transition metal oxide selected from groups I to VI as the antimicrobial active substance in polyol and water; and
c) reacting the polyol dispersion from step b1) or b2) with diisocyanate to form the polyurethane foam.

13. The method according to claim 12, wherein in step b1) or step b2), the mixing is carried out so as to set a concentration of 0.001 wt % to 10 wt %, of the transition metal oxide relative to a total weight of the polyol dispersion.

14. (canceled)

15. The polyurethane foam according to claim 12, wherein antimicrobial properties, measured according to JIS L 1902:2015, against Staphylococcus aureus (Gram+) and/or Klebsiella pneumoniae (Gram−) with an incubation time of 18 hours, having a total antibacterial activity=log [CFU]_{IGC 18h}−log [CFU]_{sample 18h}, CFU standing for colony forming units and IGC for internal growth control, is at least 0.5.
